(19) United States
(12) Patent Application Publication
(10) Pub. No.: US 2003/0074210 A1
(43) Pub. Date: Apr. 17, 2003

(54) System for creating/providing individual learning plan for learning using communication network

(76) Inventors: Masao Matsuda, Tokyo (JP); Yoshiyuki Kouyama, Osaka (JP)

Correspondence Address: YOUNG & THOMPSON, 745 SOUTH 23RD STREET 2ND FLOOR, ARLINGTON, VA, 22202

(21) Appl. No.: 10/018,003

(22) PCT Filed: Apr. 13, 2001
(86) PCT No.: PCT/JP01/03205

(30) Foreign Application Priority Data
Apr. 14, 2000 (JP) 2000-114461

(51) Int. Cl. G06F 17/60

(52) U.S. Cl. 705/1

(57) ABSTRACT

A learner individual study schedule document generating and providing system for supporting a teacher's work of providing an individual learner having a clear target with teaching materials suitable for a learner characteristic according to variations in study growth stage, comprising an access server to be connected to a communication network, a study menu Web server that is electrically connected to the access server, a learner-by-learner study menu generation server that is electrically connected to the study menu Web server, a learner study history database that is electrically connected to the learner-by-learner study menu generation server, a learner database that is electrically connected to the learner study history database, a teacher terminal that is electrically connected to the learner-by-learner study menu generation server, a study material link information database that is electrically connected to the learner-by-learner study menu generation server, a study schedule document database that is electrically connected to the learner-by-learner study menu generation server, and a telephone, a FAX, a scanner, a camera, and a microphone that are electrically connected to the teacher terminal.

### TECHNICAL FIELD

The present invention relates to a learner individual study schedule document generating and providing system for supporting a teacher's work of providing an individual learner having a clear target with teaching materials suitable for a learner characteristic according to variations in study growth stage.

### BACKGROUND ART

In education, individual study according to each learner's ability is considered ideal. Individual guidance performed by tutors or in cram schools merely remains a concept, and actually it is not what it should be. That is, an individual study guiding person's performing individual guidance using individual study materials is considered desirable and is performed actually.

However, when the subjects of individual guidance are expanded, generation of individual study teaching materials becomes costly. In practice, if it is assumed that each learner requires one individual study guiding person, it becomes impossible to assign individual study guiding persons when the number of learners becomes large. Since a learner and an individual study guiding person share the same time and place during individual study, there are restrictions in time and space.

In the above circumstances, individual study is enabled by utilizing a learning method using the Internet. The Internet enables mutual transmission of text information, figure/photograph information, or sound information, and hence enables bidirectional communication of information necessary for study. If connected to each other via the Internet, a learner and an individual study guiding person need not share the same time and place and hence are free of time-related restrictions and restrictions due to movement.

By virtue of the development of personal computers, the information processing rate and the amount of information processing can be increased easily, which has enabled individual information alteration for a number of learners.

Further, the utilization of the Internet reduces the cost of generating individual study materials. By virtue of the link function that is characteristic of the Internet, home pages all over the world can be study materials. Existing study materials can be made individual study materials by guiding a learner in selecting study materials and determining their order of use, without the need for generating new study materials.

However, conventional education methods utilizing personal computers and the Internet have the following problems. First, study materials are fixed, that is, only particular teaching materials are used; they cannot be teaching materials for individual guidance.

In the conventional education methods utilizing personal computers and the Internet, the amount of individual study is determined at the discretion of a learner. Therefore, they are not suitable for study of a learner who cannot control the amount of individual study.

Further, in the conventional education methods utilizing personal computers and the Internet, an individual study schedule is also determined at the discretion of a learner. They does not enable effective study because a learner who cannot make an optimum study schedule rarely makes an optimum study schedule.

In the conventional education methods utilizing personal computers and the Internet, individual study materials are provided by about three methods.

In the first method, the degree of proficiency of study is judged by tests. Since judgments are not performed according to the growth stage, optimum study materials cannot necessarily be provided.

The second method is arbitrary selection by a learner. It is difficult for a learner not having an ability to make optimum selection to make optimum selection.

The third method is a fixed manner of provision for each purpose of study. Needless to say, the fixed manner of provision does not match individual study scheduling.

As described above, although the utilization of the Internet provides good conditions for enabling individual study, no optimum method for individual study has not been invented yet.

An object of the invention is therefore to allow an individual study provider, a teacher, or a guiding person to provide study materials and a study menu suitable for a purpose of study using the Internet by judging a growth stage of a learner based on his scholastic ability and study characteristic.

### DISCLOSURE OF THE INVENTION

To attain the above object, the invention provides a learner individual study schedule document generating and providing system using a communication network for supporting a teacher's work of providing an individual learner having a clear target with teaching materials suitable for a learner characteristic according to variations in study growth stage, comprising an access server to be connected to the communication network, a study menu Web server that is electrically connected to the access server, a learner-by-learner study menu generation server that is electrically connected to the study menu Web server, a learner study history database that is electrically connected to the learner-by-learner study menu generation server, a learner database that is electrically connected to the learner study history database, a teacher terminal that is electrically connected to the learner-by-learner study menu generation server, a study material link information database that is electrically connected to the learner-by-learner study menu generation server, a study schedule document database that is electrically connected to the learner-by-learner study menu generation server, and a telephone, a FAX, a scanner, a camera, and a microphone that are electrically connected to the teacher terminal.

The communication network may be one or a combination of the Internet, a public lines, dedicated lines, and a radio channel.

The access server may be a server that allows only an authenticated and permitted learner to make access using an identification code.

The study menu Web server may be a web on which a schedule for an individual who has gained access is displayed.

The learner-by-learner study menu generation server may have a function of selecting study materials to be studied according to predetermined selection criteria based on a target level of the learner, a date when the target should be attained, a current degree of proficiency of the learner, and a study characteristic of the learner and determining when to present those in a distributed manner.

The study characteristic of the learner is a characteristic that depends on presence/absence and a degree of interest in what the learner studies, a degree of eagerness of the learner about what the learner studies, a degree of attitude toward study, and suitability for what the learner studies that is determined by genes.

The learner database may be a database formed by a target study level, a date when the target study level is scheduled to be reached, a name of the learner, an address of the learner, a telephone number of the learner, a FAX number of the learner, an e-mail address of the learner, a school or some other party to which the learner belongs, a position of the learner in the school or the party, recent results of the learner, a name of a protector of the learner, genetic information of the learner, and degree-of-proficiency-of-study information.

The learner study history database may be formed by a current study schedule of the learner, a study progress result of the learner, a study characteristic that is extracted from the study progress result of the learner, a current degree of proficiency of study, a study time of each study, and a study execution process.

The study material link information database may be formed by study material link information by study items, study material link information by study targets, and study material useful link information, and may be used in selecting a study schedule document of the learner.

The study schedule document database may be formed by a list of schedule tables in each of which an effective study method for attaining each of study process purposes obtained by breaking down each study purpose is shown in such a manner that study materials are arranged in date order and study order, and may be used in selecting a study schedule document of the learner.

The teacher terminal is connected to a telephone, a FAX, a scanner, a camera, and a microphone, has a function of notifying the learner about a start of study and a function of urging a person who has not studied yet to study, and can be used in manually modifying a schedule for the learner, guiding the learner, and generating materials by characteristics.

There is provided a learner individual study schedule document generating and providing method for supporting a teacher's work of providing an individual learner having a clear target with teaching materials suitable for a learner characteristic according to variations in study growth stage, comprising the steps of an access server's performing an authentication operation for the learner and allowing only an authenticated person to make access; the learner's inputting a study target level in having learner information registered in a learner database; the learner's inputting current states of the learner; and inputting gene information of the learner.

There is provided a learner individual study schedule document generating and providing method comprising a study schedule document database generation step of a teacher's forming a list of schedule tables in each of which an effective study method for attaining each of study process purposes obtained by breaking down each study purpose is shown in such a manner that study materials are arranged in date order and study order; a step of extracting degree-of-proficiency-of-study information of a learner at a start of study from a learner database; a step of extracting a study target of the learner from the learner database; extracting a study characteristic of the learner from the learner database; a step of determining basic study items of the learner based on the learner database; determining an amount of study and a study schedule of the learner based on the learner database; and a study menu Web page generation step.

There is provided a learner individual study schedule document generating and providing method comprising the steps of a learner's receiving a study start time notice; the learner's accessing an access server from a learner terminal via a communication network and having himself authenticated; the learner's accessing a study menu Web server via the access server and causing the learner terminal to display a learner schedule of a day; the learner's studying according to instructions in the learner schedule of the day; and the learner's sending results of the study made at the preceding step to the study menu Web server by a preset deadline.

There is provided a learner individual study schedule document generating and providing method characterized by comprising the steps of a teacher's necessarily checking study results after a learner reports those; if a reporting date of the study results of the learner is different from a preset deadline, a learner-by-learner study schedule generation server's modifying a schedule in accordance with the deadline; examining instruction contents that were determined in the result report; if the set learner-by-learner study schedule generation server provides proper instruction contents, modifying the instruction contents; and if late result reporting has occurred plural times or report contents have any problem, changing one or a combination of contents of study materials, the study schedule, and the teacher.

There is provided a learner individual study schedule document generating and providing method characterized by comprising the steps of a teacher's specifying study items and study materials at an initial stage where a study dependency is high but a study characteristic is high; performing specification of study items and study materials as well as advising and motivating at a second stage where scholastic ability starts to increase and the study characteristic decreases; performing only advising and motivating at a third stage where the scholastic ability increases and the study characteristic becomes unstable; and performing only passive guidance at a final stage where the scholastic ability and the study characteristic increase.

### BRIEF DESCRIPTION OF THE DRAWINGS

FIG. 1 is an explanatory diagram showing the configuration of a learner individual study schedule document generating and providing system using a communication network according to the present invention;

FIG. 2 is a flowchart relating to input by a learner in the learner individual study schedule document generating and providing system using a communication network according to the invention;

FIG. 3 is a flowchart relating to study schedule generation by a teacher in the learner individual study schedule document generating and providing system using a communication network according to the invention;

FIG. 4 is a flowchart relating to generation of an everyday study schedule of a learner in the learner individual study schedule document generating and providing system using a communication network according to the invention;

FIG. 5 is a schematic diagram showing a display picture of a monthly study schedule in the learner individual study schedule document generating and providing system using a communication network according to the invention;

FIG. 6 is a schematic diagram showing a display picture of a day's study schedule in the learner individual study schedule document generating and providing system using a communication network according to the invention;

FIG. 7 is a flowchart relating to everyday guidance by a teacher in the learner individual study schedule document generating and providing system using a communication network according to the invention;

FIG. 8 is a flowchart relating to growth stages of a learner in the learner individual study schedule document generating and providing system using a communication network according to the invention; and

FIG. 9 shows a learning curve of a learner in the learner individual study schedule document generating and providing system using a communication network according to the invention.

### BEST MODE FOR CARRYING OUT THE INVENTION

Advantages and features of other detailed configurations of the invention will become apparent from the following embodiments that will be described below with reference to the accompanying drawings.

Descriptions will be made in the following order:

1) Configuration of system according to the invention

2) Execution procedure for input by learner in system according to the invention

3) Execution procedure for study schedule generation by teacher in system according to the invention

4) Execution procedure for everyday study of learner in system according to the invention

5) Execution procedure for everyday guidance by teacher in system according to the invention

6) Execution procedure relating to growth stages of learner in system according to the invention

7) Learning curve of learner in system according to the invention

1) Configuration and Execution Procedure of System According to the Invention

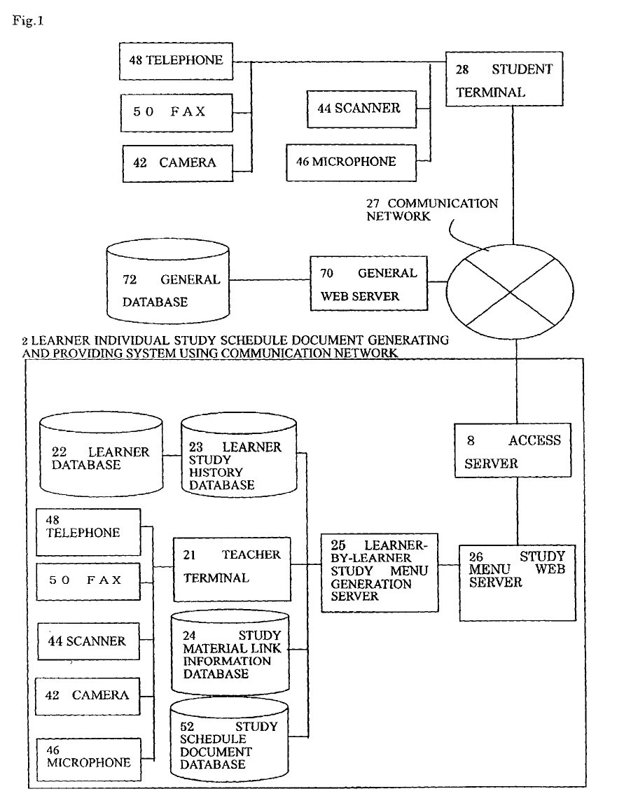

FIG. 1 is an explanatory diagram showing the configuration of a learner individual study schedule document generating and providing system using a communication network according to the invention. A learner individual study schedule document generating and providing system 2 using a communication network is electrically connected to a student terminal 28 via a communication network 27.

The learner individual study schedule document generating and providing system 2 using a communication network is composed of an access server 8 to be connected to the communication network 27, a study menu Web server 26 that is electrically connected to the access server 8, a learner-by-learner study menu generation server 25 that is electrically connected to the study menu Web server 26, a learner study history database 23 that is electrically connected to the learner-by-learner study menu generation server 25, a learner database 22 that is electrically connected to the learner study history database 23, a teacher terminal 21 that is electrically connected to the learner-by-learner study menu generation server 25, a study material link information database 24 that is electrically connected to the learner-by-learner study menu generation server 25, a study schedule document database 52 that is electrically connected to the learner-by-learner study menu generation server 25, and a telephone 48, a FAX 50, a scanner 44, a camera 42, and a microphone 46 that are electrically connected to the teacher terminal.

The access server 8 is a server for allowing only an authenticated and permitted learner to make access using an identification code. Doing authentication by this server can prevent entrance of an illegal-access-intending person.

The study menu Web server 26 is a web on which a schedule for an individual who has gained access is displayed. That is, an optimum schedule table for a leaner generated by this system is displayed in the form of a yearly schedule, a monthly schedule, or a day's schedule.

The learner-by-learner study menu generation server 25 has a function of selecting study materials to be studied according to predetermined selection criteria based on a target level of a learner, a date when the target should be attained, a current degree of proficiency of the learner, and a study characteristic of the learner and determining when to present those in a distributed manner.

The learner database 22 is a database consisting of a target study level, a date when the target study level is scheduled to be reached, the name of a learner, an address of the learner, a telephone number of the learner, a FAX number of the learner, an e-mail address of the learner, a school or some other party to which the learner belongs, a position of the learner in the school or the above party, recent results of the learner, the name of a protector of the learner, genetic information of the learner, and degree-of-proficiency-of-study information.

The learner study history database 23 consists of a current study schedule of a learner, a study progress result of the learner, a study characteristic that is extracted from the study progress result of the learner, a current degree of proficiency of study, and a study time of each study.

The study material link information database 24 consists of study material link information by study items, study material link information by study targets, and study material useful link information, and is used in selecting a study schedule document of a learner.

The study material link information by study items is a database in which Internet addresses or pieces of physical position information of individual study materials suitable for respective study items that are subdivided items of the contents of a study purpose are accumulated.

The study material link information by study targets is a database in which Internet addresses or pieces of physical position information of respective study materials for respective study targets that are determined by a school year, a subject, or the contents of an entrance examination are accumulated.

The study schedule document database 52 is a database of study materials that are classified by study targets, study purposes, study items, and effective study processes.

The study target means a degree (level) of proficiency of study that should be reached finally by study. For example, it may be a level to be reached at the end of the first year of a primary school or a level of 700 points or more in a language certification examination.

The study purpose means a middle item that is set in attaining a study target. For example, it may be addition in the first year of a primary school or hearing in a language certification examination.

The study item is a small item obtained by breaking down a study purpose into such a stage that specific problems can be generated. For example, it may be one-digit addition or hearing of conversation sentences.

The effective study process means is a specific process such as a process of understanding for mastering a study item, a process of deepening the understanding, a process of fixing the understanding, or a process of confirming the understanding. The process of understanding in a specific manner is presentation of an explanation. The process of deepening the understanding is introduction of examples, example sentences, or cases. The process of fixing the understanding is execution of exercises, observation, or presentation/speech. The process of confirming the understanding is diagnosis or advice.

The study material means a content to be used for instructing a learner in a specific manner when a study target as mentioned above is subdivided into effective study processes. For example, it is an explanation suitable for the characteristic of a learner.

Electrically connected to the teacher terminal 21 are the telephone 48, the FAX 50, the scanner 44, the camera 42, and the microphone 46. A teacher performs data input/output through the teacher terminal. Actually, he generates a study schedule document database 52 by searching the learner database 22, the learner study history database 23, and the study material link information database 24. He also modifies a study menu web generated by the learner-by-learner study menu generation server 25. The teacher terminal sends a study start notice to a learner from the learner study history database 23 by using the FAX 50 or by e-mail. The teacher terminal also urges a person who has not studied yet to study. If the functions of this apparatus produce no effect, the teacher communicates with the learner using the telephone 48.

The telephone 48 is used when the study notification function has no effect or when a learner wants to make contact or have a consultation.

The FAX 50 is used as the study notification function and is also used when a learner wants to make contact or have a consultation.

The scanner 44 is used in providing an optimum study material to a learner or a server in the form of electronic data.

The camera 42 is used in taking a still image or video to become a study material and providing it to a learner or a server. A visual telephone scheme in which a camera is used in combination with a microphone can also be used for making contact or having a consultation.

The microphone 46 can be used for sound pickup to generate or collect study materials or for constructing a visual telephone.

The communication network 27 is electrically connected to a general Web server 70, which is connected to a general database 72.

The general Web server 70 is a Web server a Web server accommodating a material that is useful for study.

The general database 72 is a database that is connected to the general Web server 70 and does not directly relate to this system, and means a database accommodating a material that is useful for study.

The study material link information database 24 provides links to the general Web server 70 and the general database 72 if they can be used as study materials.

The student terminal 28 is a terminal that is used by a learner to access the system. The learner checks a study content by accessing the study menu Web from this terminal. When it is necessary to perform investigation or search via the communication network, a connection is further established on the network. This terminal is also used in reporting a study result. A camera 42, a scanner 44, a microphone 46, a telephone 48, and a FAX 50 are electrically connected to the student terminal 28.

The telephone 48 is used to make contact or have a consultation with a teacher.

The FAX 50 is used in receiving the study notification function and to make contact or have a consultation with a teacher.

The scanner 44 is used in reporting a study result to a teacher or a server in the form of electronic data.

The camera 42 is used in taking a still image or video to become a study result and providing it to a teacher or a server. A visual telephone scheme in which a camera is used in combination with a microphone can also be used for making contact or having a consultation.

The microphone 46 can be used for sound pickup to generate or collect study results or for constructing a visual telephone.

2) Execution Procedure for Input by Learner in System According to the Invention

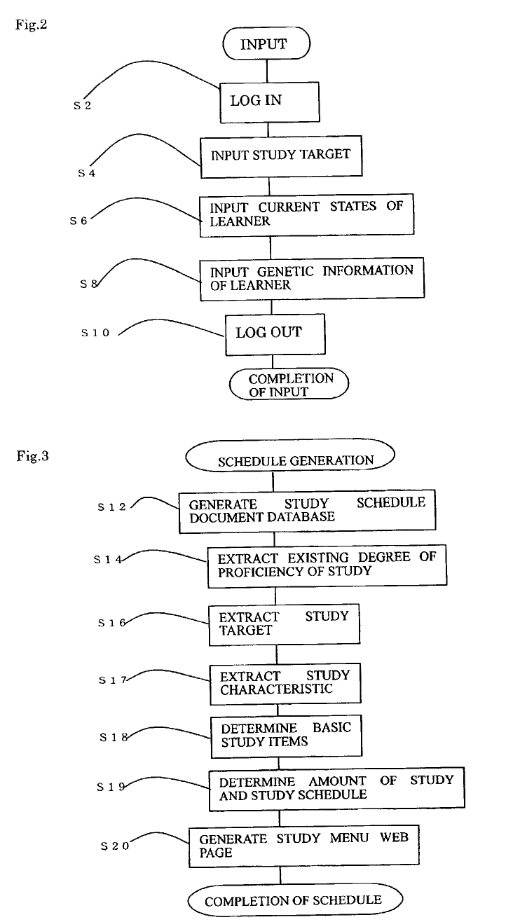

FIG. 2 is a flowchart relating to input by a learner in the learner individual study schedule document generating and providing system using a communication network according to the invention.

An input process is a process in which information relating to a study characteristic of a learner at the time of a start of study is input and data to be used for generating a study schedule are registered in the learner database.

A first step is a step in which the learner accesses the access server 8 from the student terminal 28 and the access server performs an authentication operation for the learner and permits only an authenticated person to make access. Establishing a connection to only a permitted person at this step is a safety measure of the system.

A second step is a step in which the learner inputs a study target level in having learner information registered in the learner database. A necessary degree of proficiency of study as a study target and a deadline when to reach that level are input.

A third step is a step in which the learner inputs his current states. For example, this is a step in which the name the learner, an address of the learner, a telephone number of the learner, a FAX number of the learner, an e-mail address of the learner, a school or some other party to which the learner belongs, a position of the learner in the school or the above party, recent results of the learner, the name of a protector of the learner, and degree-of-proficiency-of-study information are input.

A fourth step is a step in which genetic information of the learner is input. That is, information recognized in advance such as an acquired character or a physiological feature such as the learner's having a gene arrangement for forming in advance nerve cell connections in the brain having a high mathematical logic capability is registered.

Execution of this process makes it possible to determine initial states of the learner and collect all data that are necessary to generate a study schedule.

3) Execution Procedure Relating to Study Schedule Generation by Teacher in System According to the Invention

FIG. 3 is a flowchart relating to study schedule generation by a teacher in the learner individual study schedule document generating and providing system using a communication network according to the invention.

This process is a procedure in which a teacher generates schedule documents for various cases in advance by generating study materials that can be prepared in advance and generates a study menu Web page based on the learner database that was input in the input process of item 2).

A first step is a step of generating a study schedule document database. A database of study materials that are classified by study targets, study purposes, study items, and effective study processes is generated. A study schedule document is generated so that classification can be made by stages that are an initial stage, a second stage, a third stage, and a final stage (described later) in addition to the above categories.

A second step is a step of extracting the degree-of-proficiency-of-study information of the learner at the time of the start of study.

A third step is a step of extracting the study target of the learner from the learner database.

A fourth step of a step of extracting the study characteristic of the learner from the learner database.

A fifth step is a step of determining basic study items of the learner based on the learner database.

A sixth step is a step of determining an amount of study and a study schedule of the learner based on the learner database.

A seventh step is a study menu Web page generation step.

Execution of this process makes it possible to generate an individual study schedule because study materials are determined based on the study target and a schedule is then determined.

4) Execution Procedure for Everyday Study of Learner in System According to the Invention

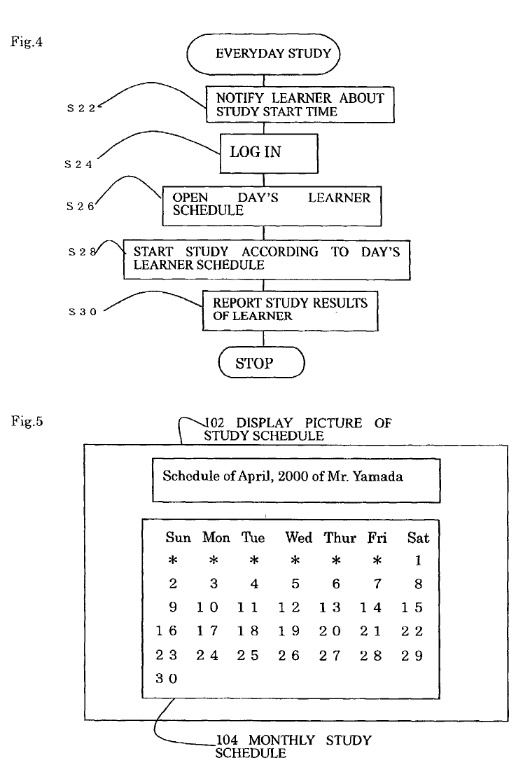

FIG. 4 is a flowchart relating to generation of an everyday study schedule of a learner in the learner individual study schedule document generating and providing system using a communication network according to the invention. FIG. 5 is a schematic diagram showing a display picture of a monthly study schedule. FIG. 6 is a schematic diagram showing a display picture of a day's study schedule.

This procedure is a procedure of actual everyday study of the learner.

At a first step, a study start time notice is received that is sent by FAX or e-mail. That is, this is intended to notify the learner about study start time and to urge learners who have not studied yet to study.

At a second step, the learner accesses the access server from the learner terminal over the communication network and has himself authenticated. That is, establishing a connection to only a permitted person at this step is a safety measure of the system.

At a third step, the learner accesses the study menu Web server via the access server and has a day's learner schedule on the learner terminal. FIGS. 5 and 6 show study schedules. FIG. 5 shows a monthly study schedule 104, and a date portion of this picture is linked to a day's study schedule 206. FIG. 6 shows a Todo list 208 for a particular individual, date, and subject. Study contents of the day and a link destination of a content or the like are shown. A visual telephone 210 can also be used at the same time to enable a consultation about an unclear point.

At a fourth step, the learner studies according to instructions in the day's learner schedule.

At a fifth step, the learner sends, to the study menu Web server, by a preset deadline, results of the study that was done at the preceding step.

Execution of this process makes it possible to present study materials for each person as well as to provide a wider variety of study materials using links.

5) Execution Procedure for Everyday Guidance by Teacher in System According to the Invention

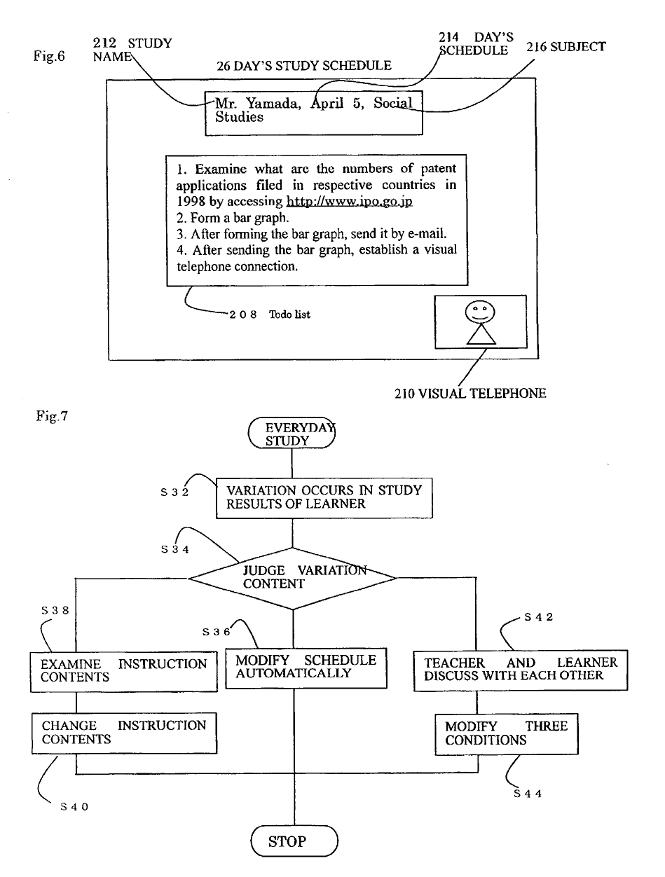

FIG. 7 is a flowchart relating to everyday guidance by a teacher in the learner individual study schedule document generating and providing system using a communication network according to the invention.

This process consists of a process in which a schedule is automatically modified based on study results of the learner and a process in which the teacher takes a proper measure by making a judgment by himself.

At a first step, study results are necessarily checked after the learner reports those. That is, it is checked whether study results have been reported and whether study results have any abnormality.

At a second step, if the reporting date of the study results of the learner is different from the preset deadline, the learner-by-learner study schedule generation server modifies the schedule in accordance with the deadline.

At a third step, if the teacher has found a more effective study method in judging a variation content, instruction contents that were determined in the result report are examined.

At a fourth step, if the set learner-by-learner study schedule generation server provides proper instruction contents, the instruction contents are modified.

At a fifth step, if late result reporting has occurred plural times or the report contents have any problem, one or a combination of the contents of study materials, the study schedule, and the teacher is changed.

Execution of this process makes it possible to follow individual study at each stage and to thereby allow each learner to study according to his characteristic.

6) Execution Procedure Relating to Growth Stages of Learner in System According to the Invention

FIG. 8 is a flowchart relating to growth stages of a learner in the learner individual study schedule document generating and providing system using a communication network according to the invention.

This chart shows a relationship between the scholastic ability for establishment of independent study, the study characteristic, and the course of study guidance as well as an independent study transition process. This is a process used in generating a study schedule. The course of study guidance needs to be changed according to this process.

At an initial stage, the scholastic ability remains the same level and does not increase because of an insufficient study time. As for the study characteristic, the effectiveness of study is high because there are a number of unknown items, which is a feature found particularly in an initial stage of study. In terms of the transition process of independent study, the dependency of study is high because of low independency inherent in an individual and hence the social cost is high. As for the course of study guidance, a presentation method is mainly employed and it is necessary to specify a study item or a study material.

At a second stage, the scholastic ability starts to increase slowly because the study time increases. However, the study characteristic decreases because the freshness at the initial stage is lost. In terms of the transition of independent study, the degree of independent study increases to about 50% and the dependency of study decreases. Therefore, as for the course of study guidance, a support method is added to the presentation method; advising and motivating (50% each) are added to the presentation of study items and study materials at the initial stage.

At a third stage, the scholastic ability continues to increase. However, the study characteristic becomes unstable. In terms of the transition process of independent study, the degree of independent study accounts for about 80%. Therefore, as for the course of study guidance, advising and motivating (support method) play a key role.

At a final stage, the scholastic ability as well as the study characteristic increases remarkably. In terms of the transition process of independent study, completely independent study is made. And the study cost of a learner becomes a return to the society in contrast to the fact that it was a social cost at the initial stage. Therefore, the course of study guidance is establishment of independent study.

That is, generating a schedule in consideration of this process makes it possible to reduce the presentation amount according to the stage of a learner to effect conversion into a support type, and to finally aim at establishment of independent study of the learner.

7) Learning Curve of Learner in System According to the Invention

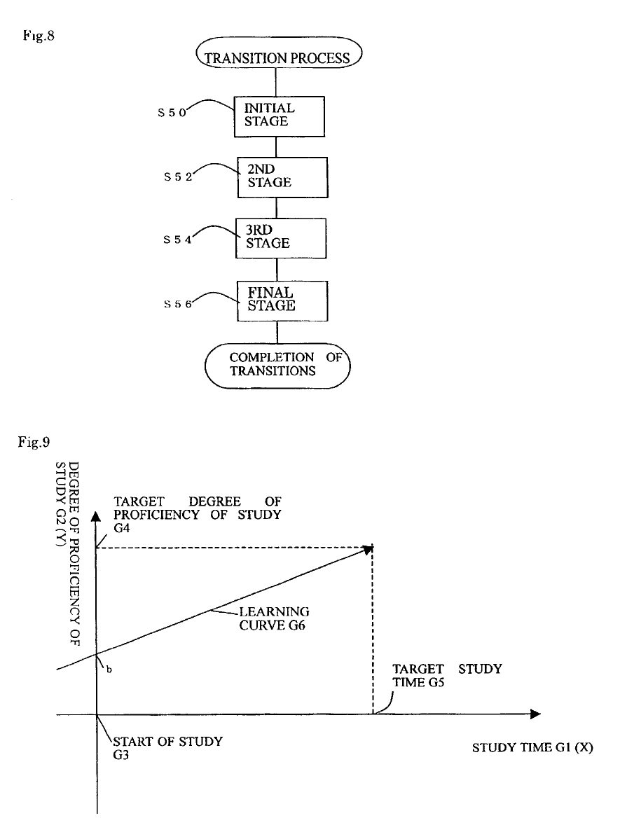

FIG. 9 shows a learning curve of a learner in the learner individual study schedule document generating and providing system using a communication network according to the invention.

This curve indicates a degree-of-proficiency-of-study calculation method based on which a study schedule as described above is generated.

The degree of proficiency of study y is calculated according to y=ax+b, where a is the study characteristic that depends on interest, eagerness, attitude, and suitability determined by genes, x is the study time, and b is the degree of proficiency of study at the start of study. This curve is shown as a learning curve G6 in FIG. 9. The horizontal axis represents the study time G1 and the vertical axis represents the degree of proficiency of study G2. The origin corresponds to the start of study G3. The intercept is the degree of proficiency b at the start of study. A value f of an integral ∫ ydx from 0 to x means an amount of study.

A time that will be taken to reach a study target can be estimated by quantifying a study schedule according to this curve.

The basic constitution of the invention and its typical embodiments have been described above. However, it would be understood that a person having ordinary skill in the art can make various design modifications without departing from the spirit and scope of the invention.

Implementing the learner individual study schedule document generating and providing system using a communication network according to the invention allows an individual study provider, a teacher, or a guiding person to provide study materials and a study menu suitable for a purpose of study using the Internet by judging a growth stage of a learner based on his scholastic ability and study characteristic.

1. A learner individual study schedule document generating and providing system for supporting a teacher's work of providing an individual learner having a clear target with teaching materials suitable for a learner characteristic according to variations in study growth stage, comprising an access server to be connected to a communication network, a study menu Web server that is electrically connected to the access server, a learner-by-learner study menu generation server that is electrically connected to the study menu Web server, a learner study history database that is electrically connected to the learner-by-learner study menu generation server, a learner database that is electrically connected to the learner study history database, a teacher terminal that is electrically connected to the learner-by-learner study menu generation server, a study material link information database that is electrically connected to the learner-by-learner study menu generation server, a study schedule document database that is electrically connected to the learner-by-learner study menu generation server, and a telephone, a FAX, a scanner, a camera, and a microphone that are electrically connected to the teacher terminal.

2. The learner individual study schedule document generating and providing system according to claim 1, characterized in that the communication network is one or a combination of the Internet, a public lines, dedicated lines, and a radio channel.

3. The learner individual study schedule document generating and providing system according to claim 1 or 2, characterized in that the access server is a server that allows only an authenticated and permitted learner to make access using an identification code.

4. The learner individual study schedule document generating and providing system according to any one of claims 1 to 3, characterized in that the study menu Web server is a web on which a schedule for an individual who has gained access is displayed.

5. The learner individual study schedule document generating and providing system according to any one of claims 1 to 4, characterized in that the learner-by-learner study menu generation server has a function of selecting study materials to be studied according to predetermined selection criteria based on a target level of the learner, a date when the target should be attained, a current degree of proficiency of the learner, and a study characteristic of the learner and determining when to present those in a distributed manner.

6. The learner individual study schedule document generating and providing system according to claim 5, characterized in that the study characteristic of the learner is a characteristic that depends on presence/absence and a degree of interest in what the learner studies, a degree of eagerness of the learner about what the learner studies, a degree of attitude toward study, and suitability for what the learner studies that is determined by genes.

7. The learner individual study schedule document generating and providing system according to any one of claims 1 to 6, characterized in that the learner database is a database formed by a target study level, a date when the target study level is scheduled to be reached, a name of the learner, an address of the learner, a telephone number of the learner, a FAX number of the learner, an e-mail address of the learner, a school or some other party to which the learner belongs, a position of the learner in the school or the party, recent results of the learner, a name of a protector of the learner, genetic information of the learner, and degree-of-proficiency-of-study information.

8. The learner individual study schedule document generating and providing system according to any one of claims 1 to 7, characterized in that the learner study history database is formed by a current study schedule of the learner, a study progress result of the learner, a study characteristic that is extracted from the study progress result of the learner, a current degree of proficiency of study, a study time of each study, and a study execution process.

9. The learner individual study schedule document generating and providing system according to any one of claims 1 to 8, characterized in that the study material link information database is formed by study material link information by study items, study material link information by study targets, and study material useful link information, and is used in selecting a study schedule document of the learner.

10. The learner individual study schedule document generating and providing system according to any one of claims 1 to 9, characterized in that the study schedule document database is formed by a list of schedule tables in each of which an effective study method for attaining each of study process purposes obtained by breaking down each study purpose is shown in such a manner that study materials are arranged in date order and study order, and is used in selecting a study schedule document of the learner.

11. The learner individual study schedule document generating and providing system according to any one of claims 1 to 10, characterized in that the teacher terminal is connected to a telephone, a FAX, a scanner, a camera, and a microphone, has a function of notifying the learner about a start of study and a function of urging a person who has not studied yet to study, and can be used in manually modifying a schedule for the learner, guiding the learner, and generating materials by characteristics.

12. A learner individual study schedule document generating and providing method for supporting a teacher's work of providing an individual learner having a clear target with teaching materials suitable for a learner characteristic according to variations in study growth stage, comprising the steps of an access server's performing an authentication operation for the learner and allowing only an authenticated person to make access; the learner's inputting a study target level in having learner information registered in a learner database; the learner's inputting current states of the learner; and inputting gene information of the learner.

13. A learner individual study schedule document generating and providing method comprising a study schedule document database generation step of a teacher's forming a list of schedule tables in each of which an effective study method for attaining each of study process purposes obtained by breaking down each study purpose is shown in such a manner that study materials are arranged in date order and study order; a step of extracting degree-of-proficiency-of-study information of a learner at a start of study from a learner database; a step of extracting a study target of the learner from the learner database; extracting a study characteristic of the learner from the learner database; a step of determining basic study items of the learner based on the learner database; determining an amount of study and a study schedule of the learner based on the learner database; and a study menu Web page generation step.

14. A learner individual study schedule document generating and providing method comprising the steps of a learner's receiving a study start time notice; the learner's accessing an access server from a learner terminal via a communication network and having himself authenticated; the learner's accessing a study menu Web server via the access server and causing the learner terminal to display a learner schedule of a day; the learner's studying according to instructions in the learner schedule of the day; and the learner's sending results of the study made at the preceding step to the study menu Web server by a preset deadline.

15. A learner individual study schedule document generating and providing method characterized by comprising the steps of a teacher's necessarily checking study results after a learner reports those; if a reporting date of the study results of the learner is different from a preset deadline, a learner-by-learner study schedule generation server's modifying a schedule in accordance with the deadline; examining instruction contents that were determined in the result report; if the set learner-by-learner study schedule generation server provides proper instruction contents, modifying the instruction contents; and if late result reporting has occurred plural times or report contents have any problem, changing one or a combination of contents of study materials, the study schedule, and the teacher.

16. A learner individual study schedule document generating and providing method characterized by comprising the steps of a teacher's specifying study items and study materials at an initial stage where a study dependency is high but a study characteristic is high; performing specification of study items and study materials as well as advising and motivating at a second stage where scholastic ability starts to increase and the study characteristic decreases; performing only advising and motivating at a third stage where the scholastic ability increases and the study characteristic becomes unstable; and performing only passive guidance at a final stage where the scholastic ability and the study characteristic increase.
